(19) United States
(12) Patent Application Publication
(10) Pub. No.: US 2005/0062177 A1
(43) Pub. Date: Mar. 24, 2005

(54) Compression wave injection carburetor

(75) Inventor: Scott R. Shaw, Nashville, TN (US)

Correspondence Address: ORRICK, HERRINGTON & SUTCLIFFE, LLP, 4 PARK PLAZA, SUITE 1600, IRVINE, CA, 92614-2558, US

(73) Assignee: ZAMA JAPAN

(21) Appl. No.: 10/665,830

(22) Filed: Sep. 19, 2003

(51) Int. Cl. F02M 7/22

(52) U.S. Cl. 261/51; 261/60

(57) ABSTRACT

A carburetor including a butterfly-like throttle valve on an air intake pathway and a fuel nozzle positioned in an air-fuel pathway positioned between the air intake pathway and a fuel metering chamber. A metering pin retained by an actuating member that reciprocates linearly and remains in constant contact with a cam face of a cam member located on a valve stem. Fuel supplied to the air-fuel intake pathway from a constant fuel chamber via the fuel nozzle is controlled according to the opening and closing of a throttle. The metering pin by means of a cam controls the volume of the fuel flow rate at a desired stroke set irrespective of the opening and closing movement of the throttle valve.

### FIELD OF THE INVENTION

The invention primarily relates to carburetors for supplying fuel to general-purpose engines and, more particularly, relates to a carburetion system for compression wave fuel injection.

### BACKGROUND OF THE INVENTION

Small high speed two-stroke engines are typically utilized in handheld power equipment such as leaf blowers, trimmers and chain saws, and also with small outboard boat engines, lawnmowers, snowblowers and the like. The small two-stroke engine has many desirable characteristics that facilitate the above uses, such as simplicity of construction, low cost of manufacturing, high power-to-weight ratios, high speed operational capability and ease of maintenance.

A major drawback of these engines, however, is the loss of a portion of unburned fuel from the cylinder during the scavenging process. The loss of fuel tends to cause poor fuel economy and, most importantly, high emission of unburned hydrocarbon, thus tending to render the simple two-stroke engine incapable of compliance with increasingly stringent governmental regulations regarding emissions.

Separating the scavenging of the cylinder, with fresh air, from the charging of the cylinder, with fuel, has been shown to relieve this fuel loss. The separation is achieved by injecting liquid fuel into the cylinder or more preferably by injecting the fuel charge by utilizing a pressurized air source, separate from the fresh air scavenge, to spray the fuel into the cylinder. The latter is utilized in compression wave injection (CWI) engines.

In the CWI engine, the fuel charge is carried by a small amount of air into a compression injection tube, where it is injected directly into the cylinder, bypassing the crankcase of the engine. (see U.S. Pat. No. 6,578,562) The air charge is inducted through the crankcase as usual. The carburetor on the CWI engine must meter the fuel into the CWI port, and simultaneously meter the air into the crankcase, so that the proper air/fuel ratio is maintained in the cylinder. As shown in U.S. Pat. Nos. 6,578,562, and 6,427,646, a hole in the throttle shaft gates the fuel to the CWI path in synch with a butterfly throttle valve controlling the air to the cylinder. This design, however, has its shortcomings.

For instance, because the CWI engine needs to have the CWI port located above the normal air intake port on the engine cylinder, the use of a standard butterfly valve carburetor tends to result in the need for a long manifold passage with several 90° turns in the fuel path. The long flow path and the turns in the flow path have been shown to cause fuel puddling that results in unstable idle at various engine positions and orientations. The long manifold path is also difficult to manufacture and results in the need for various additional gaskets that add to the cost and open up additional potential leak paths.

Another problem inherent in the existing designs of CWI carburetors is vapor lock. On a conventional carburetor the vaporization of the fuel occurs in a large stream of air within the center of the carburetor, which results in a substantial cooling of the carburetor body. This cooling prevents the fuel coming into the carburetor from flashing into vapor before it has been metered. On the CWI carburetor, the fuel is vaporized in a very small amount of air, and this vaporization occurs away from the central body of the carburetor, cooling only a small spot of the body. The remaining portion of the carburetor body is free to rise above the ambient air temperatures due to engine heating and the fuel entering the carburetor can flash into vapor before the fuel is metered. This can cause a severe enleanment of the fuel/air mixture resulting in unstable operation or stalling or in the worst case, elevated engine temperatures and engine failure.

The control of the CWI fuel with a rotating hole across the throttle shaft also provides limitations on the ability to control the air/fuel ratio at all but idle and full throttle conditions. It is desirable to have a precise air/fuel ratio throughout the entire throttle range to provide acceptable performance to the end consumer.

The control of the fuel supply by a metering pin in response to axial movement of a sliding or rotary throttle valve is beneficial in that it requires no special consideration for fuel-related connections and includes a simple pathway structure. However, the sliding valve linearly reciprocates along a length nearly identical to the diameter of the air intake pathway. As a result, a spacing of a size at least equivalent to the stroke of the sliding throttle valve must be provided between a constant fuel chamber, and the opening of the fuel nozzle to the air-fuel pathway in order to accommodate a metering pin that operates integrally with the sliding throttle valve. For this reason, the air-fuel pathway cannot be made sufficiently small. The rotary throttle valve moves slightly in the central axial direction as it rotates so that a metering pin that moves integrally with the rotating throttle valve can control the amount of fuel supplied. Because minute movements of the metering pin control the required fuel amounts for all operating levels of the engine, the dimensional and positional relationships between the fuel nozzle and the metering pin have to be set with a high degree of accuracy, which poses design and manufacturing problems.

### SUMMARY OF THE INVENTION

The present invention provides a diaphragm-type carburetor comprising an air intake and air-fuel pathways that penetrate a body, a constant fuel chamber that is provided along one face of the body and contains a constant amount of fuel by means of a diaphragm, a butterfly-type throttle valve that opens and closes the air intake pathway, a fuel nozzle that supplies fuel introduced from the constant fuel chamber to the air-fuel pathway, a metering pin having a tip thereof inserted into the fuel nozzle, a cam member centered on a valve stem of the throttle valve and having an arc-shaped cam face, and an actuating member that makes constant contact with the cam face and reciprocates linearly. The metering pin, which is held by the actuating member, reciprocates linearly following the opening and closing of the throttle valve, and controls the amount of fuel supplied from the fuel nozzle to the air-fuel pathway and the flow of air through the air-fuel pathway.

In the above embodiment of the invention, the actuating member has a contact portion that makes contact with the cam face and a retaining member for retaining the contact portion in contact with the cam face. The force of a spring acts to place the contact portion in contact with the cam face. A follower member, which is c-shaped, is positioned about the cam member. A actuating member configuration is preferred for smooth and accurate conversion of the opening and closing motion of the throttle valve into linear reciprocating motion of the metering pin.

In the above embodiment of the present invention, the throttle lever—which is attached to the valve stem so that movement associated with acceleration control is transmitted to and opens or closes the throttle valve—may, in the alternative, act as a cam member as well in order to reduce the number of parts.

In an alternate embodiment, an adjustable fuel nozzle is moveably positioned within the body of the carburetor to enable adjustment of the amount of fuel flowing to the air-fuel passage independent air flow through the air-fuel passage.

Further, objects and advantages of the invention will become apparent from the following detailed description and accompanying drawings.

### BRIEF DESCRIPTION OF THE DRAWINGS

FIG. 1 is a partial schematic diagram of a carburetor in accordance with the present invention coupled to a prior art compression wave injection engine.

FIGS. 2A-2E are partial schematic diagrams of the prior art engine shown in FIG. 1 at various operational positions.

FIG. 3 is a longitudinal sectional view of the carburetor of the present invention.

FIG. 4 is an end view of an alternate embodiment of the carburetor shown in FIG. 3.

FIG. 5A is a plan view of the actuating member, metering pin and fixed fuel nozzle assembly shown in FIG. 3.

FIG. 5B is a plan view of the actuating member, metering pin and adjustable fuel nozzle assembly shown in FIG. 4.

FIG. 6 is a plan view of an alternative embodiment of the actuating member, metering pin and fuel nozzle assemblies shown in FIGS. 3, 4, 5A and 5B.

### DETAILED DESCRIPTION OF THE PREFERRED EMBODIMENT

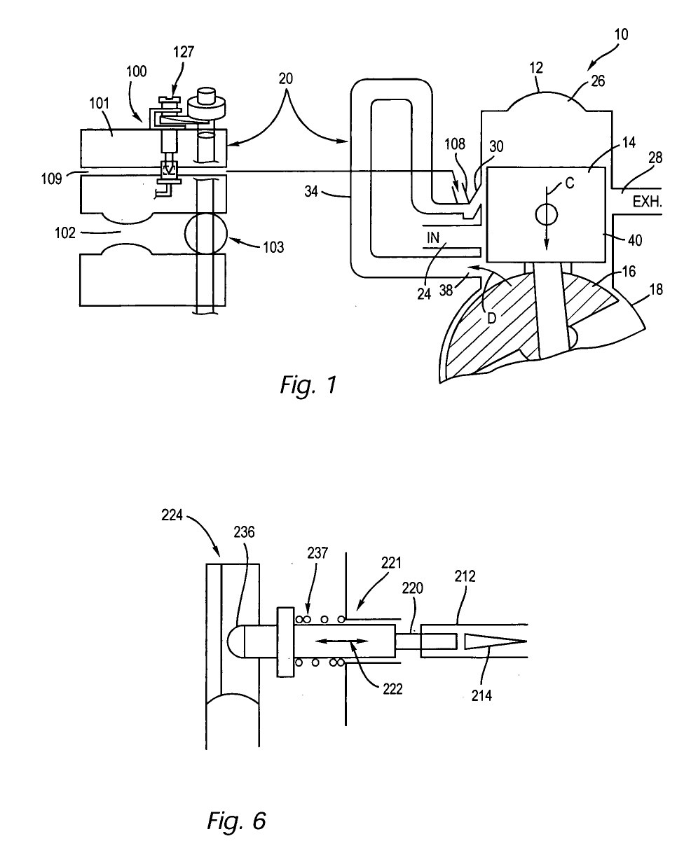

A preferred embodiment of the carburetor of the present invention will be discussed in reference to the drawings. Turning first to FIG. 1, there is shown a schematic view of a compression wave injection (CWI) internal combustion engine 10 of the prior art and a CWI carburetor 100 in accordance with the present invention. The engine 10 is a two-stroke engine having a cylinder 12, a piston 14, a crankshaft 16, a crankcase 18, and a fuel delivery system 20 comprising the carburetor 100 of the present invention and an accumulator 34. The cylinder 12 has a top, a bottom which is connected to the crankcase 18, an inlet 24, a combustion chamber 26, an exhaust outlet 28, and an injection port or inlet 30 into the combustion chamber 26. The injection port 30, as depicted, is typically located in a side wall of the cylinder 12 and is shaped to direct fuel and air in an upward direction towards the top of the cylinder head.

The accumulator 34 has an inlet 38 connected to the crankcase 18 and an exit at the injection port 30. The accumulator 34 collects and temporarily stores compressed air scavenged from the crankcase 18. The piston 14 compresses the air in the crankcase 18 on the piston's downward stroke. As depicted, the injection port 30 is provided above the air inlet 24 and the accumulator inlet 38 is provided below the air inlet. Both apertures 30 and 38, as a result of their position, are piston ported wherein the piston head 40 is sized and shaped to open and close access through the apertures 30, 38 as the piston head 40 reciprocates up and down in the cylinder 12. The accumulator 34 is a simple channel between the two apertures 30, 38. Timing of the opening and closing of the ports 30, 38 depends upon location of the ports along the length of the cylinder 12.

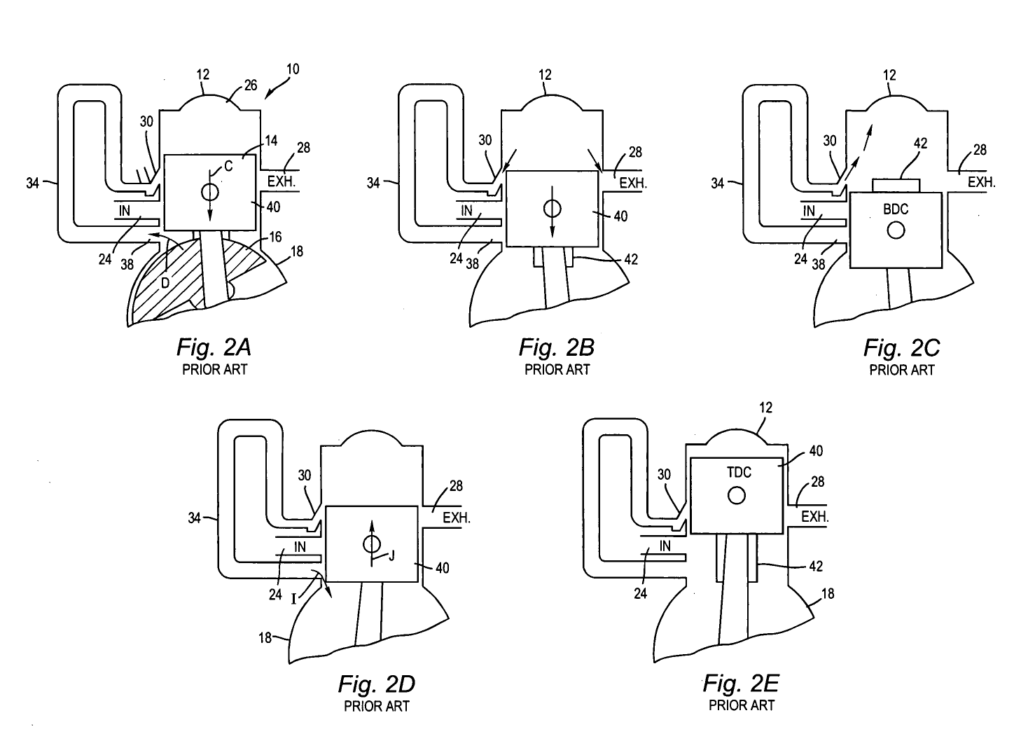

Operation of the fuel delivery system is illustrated in FIGS. 2A-E. FIG. 2A shows the piston head 40 at about 90°, after top dead center (ATDC), moving downward in the cylinder 12 as shown by arrow C away from the top dead center position of the piston head 40. The piston head 40 is blocking the inlet 30, the exhaust outlet 28 and the air inlet 24, but the accumulator inlet 38 is open. With the piston head 40 moving towards the crankcase 18, air from inside the crankcase 18 is pushed into the accumulator 34 through the inlet 38 as indicated by arrow D. As the piston head 40 moves towards the position illustrated in FIG. 2B, the piston head 40 begins to uncover and open the inlet 30 and starts to block and close the accumulator inlet 38. As depicted, the piston head uncovers the inlet 30 at about 115° of rotation of the crankshaft ATDC and completely closes the inlet 38 at about the same time the piston head opens access to the transfer channel 42 (see FIG. 2C) when the transfer 42 opens. The accumulator inlet 38 is effectively closed by the piston head 40 while the injection inlet 30 is open.

The accumulator 34 and the carburetor 100 deliver mostly fuel to the combustion chamber using a vacuum to pull fuel from the carburetor 100 into the accumulator 34, using compressed air from the crankcase 18 into the accumulator 34, and using a reflected compression wave in the accumulator 34. As the reflected compression wave in the accumulator 34 exits the inlet 30 it causes the fuel and air in the cylinder 12 to be greatly disturbed; in effect functioning as a shock wave. This helps to atomize the fuel and distribute the fuel better in the air. In addition, the reflected compression wave assists in removing fuel droplets that might be adhering to tips or edges of the inlet 30 by surface adhesion or surface tension. The compression wave shocks the fuel off of the surface and into the cylinder 12. The compressed air continues to push fuel out the inlet 30 until the inlet is closed by the piston head again as shown in FIG. 2D. The residual air in the accumulator 34 after the inlet 30 is closed, just after 2D, is still pressurized. The inlet 30 completely closes shortly before the exhaust outlet 28 is closed. The accumulator inlet 38 opens at substantially the same time the injection inlet 30 is closed. The opening of the inlet 38 functions as a blow off port to relieve residual pressure from the compressed air in the accumulator 34 back into the crankcase 18 as shown by arrow I in FIG. 2D. Relieving pressure from the accumulator 34 when the inlet 30 is closed prevents an excessive amount of fuel from being pushed between the piston head 40 and the inside cylinder wall that could otherwise raise hydrocarbon emissions.

With the piston head 40 rising as shown by arrow J in FIG. 2D towards the TDC position, crankcase pressure drops below 1 atmosphere. Thus, when aperture 38 is opened, not only is pressure in the accumulator 34 relieved, but a vacuum pressure is created in the accumulator 34. This vacuum pressure is used to pull fuel from the carburetor 100 and thus assist in delivering fuel into the accumulator. Referring also to FIG. 2E the piston head 40 is shown at its TDC position with the air inlet 24 open.

Turning to FIGS. 1, 3, 4, 5A and 5B, the carburetor 100 in accordance with the present invention introduces air into the crankcase 18 which is pushed through channel 42 into the combustion chamber and fuel, substantially separate from air, directly into the accumulator 34 adjacent the injection port 30 to be entrained or pushed into the combustion chamber 26.

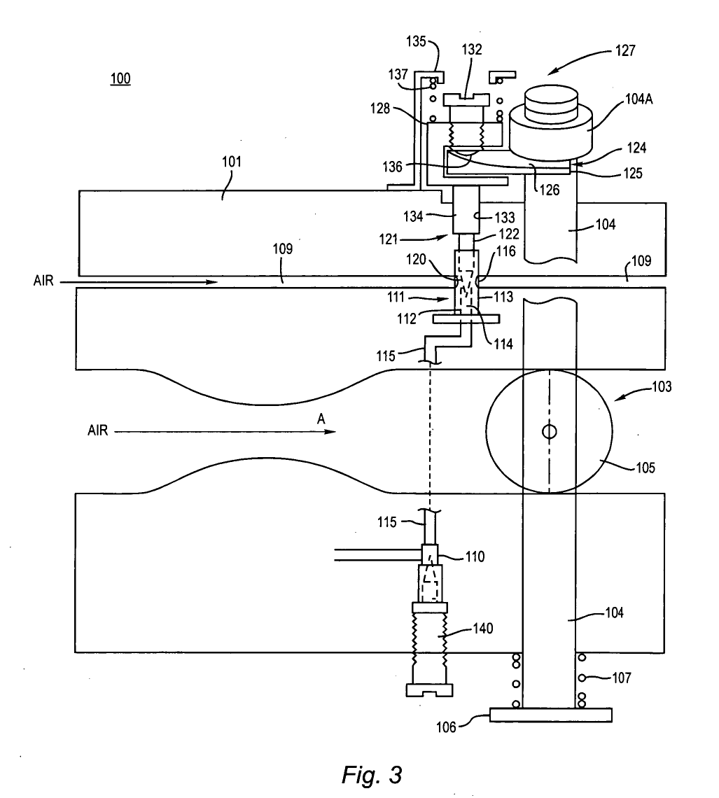

In FIGS. 1 and 3, a preferred embodiment of the present invention is shown to include an air intake pathway 102 formed through a body 101, and a conventional butterfly-type throttle valve 103 comprising a valve plate 105 composed of a disk attached to a valve stem 104 that is rotatably supported on the body 101. The valve stem 104 orthogonally crosses the air intake pathway 102 and protrudes at both ends from the body 101. Air coming from an air cleaner (not shown) passes through the throttle valve 103 flowing in the direction of Arrow A, to supply air to the crank case 18.

In this embodiment, a throttle lever 106 affixed to one end of the valve stem 104 is pulled and rotated by acceleration controls to open and close the throttle valve 103. Optimally, the throttle valve 103 can be closed under the force of a return spring 107 comprising a screw coil spring attached to the same end of the valve stem 104, which is a commonly known configuration.

The preferred embodiment of the present invention further includes an air-fuel pathway 109 formed through the body 101. Unlike conventional carburetors, the air-fuel pathway 109 does not pass through the valve stem 104. The air-fuel pathway 109 is preferably positioned above the air intake pathway 102 and below the fuel-metering chamber (not shown) of the carburetor 100. As a result, fuel vaporization advantageously occurs directly below the fuel-metering chamber with the maximum benefits from the cooling effects of vaporization being received by the fuel-metering chamber. In addition, with the air-fuel pathway 109 positioned above the air intake 102, the carburetor 100 advantageously is able to be oriented relative to the engine in a conventional manner eliminating the need for complex manifolding and simplifying the manufacture of the carburetor and/or engine.

The exit of the air-fuel pathway 109 is preferably coupled through an fuel port 108 to the accumulator 34 of the engine 10 adjacent the inlet 30 to the compression chamber 26. A high speed fuel nozzle 110 that regulates the maximum flow rate of the fuel from the constant fuel chamber to the air-fuel pathway 109 is disposed in the fuel passageway 115 leading from the constant fuel chamber. The high speed fuel nozzle 110 includes an adjustable metering needle 140 having a tip that alters the aperture of the fuel nozzle 110 when the needle 140 is adjusted.

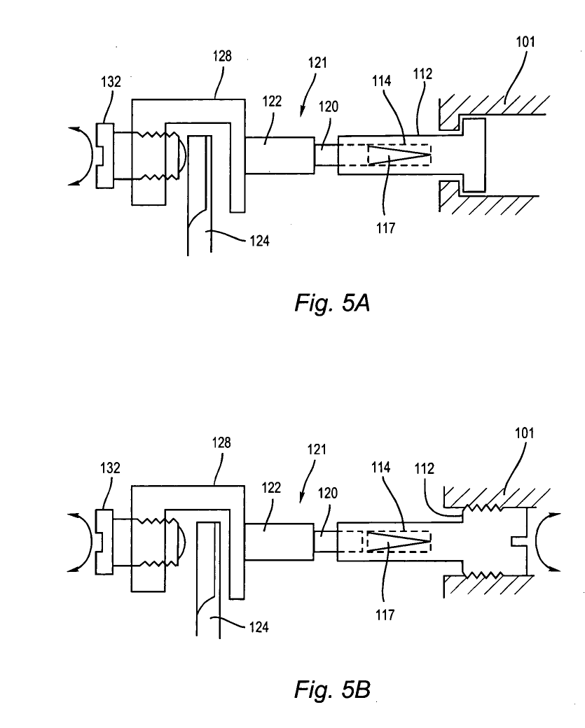

An air-fuel nozzle 111 that supplies fuel from the fuel passageway 115 to the air-fuel pathway 109 and meters air through the air-fuel pathway 109 is disposed in the air-fuel pathway 109. The air-fuel nozzle 111 comprises a pipe 113 having a fuel nozzle 112 disposed therein. The nozzle 112 includes a fuel metering hole 114 connected to the fuel passageway 115 leading from the high speed fuel nozzle 110 and an aperture 117 open thereto (see also FIG. 5A). The air-fuel nozzle 111 also includes an air metering hole 116 that extends through the pipe 113 in an axial direction along the air-fuel pathway 109.

A metering pin 121, which is positioned parallel to the valve stem 104, includes a tip 120 that is inserted in the fuel metering hole 114 of the fuel nozzle 112 to meter fuel passing through the aperture 117 and a slide portion 122 that is inserted in the pipe 113 to throttle the air passing through the air-fuel pathway 109. Fuel entering the fuel metering hole 114 from the constant fuel chamber via the high speed fuel nozzle 110 and fuel passageway 115 is metered by the tip 120 of the metering pin 121, and is supplied to the air-fuel pathway 109 via the air metering hole 116. The metering pin 121 reciprocates linearly so as to set the aperture 117 and the air metering hole 116 to the minimum opening when the engine is idling and to the maximum opening when the engine is at full output, and maintain the air/fuel ratio at a consistent level.

A small-diameter component 104A is formed on the other end of the valve stem 104, opposite the throttle lever 106. A disc-shaped cam member 124 is joined to the small-diameter component stem 104A. The cam member 124 comprises an arc-shaped cam 125 that is centered on the valve stem 104. A cam surface 126 thereof faces a direction opposite the body 101.

A C-shaped following member 128 is disposed on the same side of the body 101 as the cam member 124. An adjustable follower 132 is rotatably disposed in the top leg of the following member 128 and contacts the cam surface 126 of the cam member 124. A spring 137 and retaining member 135 biases the follower 132 against the cam surface 126.

Extending from the bottom leg of the following member 128 is a needle holder 134. The needle holder 134 is slidably and hermetically received in a retaining hole 133 provided in the body 101. A base end of the slide portion 122 of the metering pin 121 is coupled to the tip of the needle holder 134.

The following member 128, the follower 132 with a contact portion 136, the retaining member 135, which retains the following member 128, and the needle holder 134, constitute an actuating member 127 that causes the metering pin 121 to reciprocate linearly following the angular reciprocating movement of the cam member 124 and ensures synchronization between the air flow and the fuel flow through all throttle positions from idle to wide open throttle.

Once this embodiment is assembled, the depth of insertion of the tip 120 of the metering pin 121 into the fuel hole 114 and the slide portion 122 into the pipe 113 during idling in particular (i.e., the effective opening of the aperture 117 and air metering hole 116) is adjusted as necessary by rotating the adjustment screw portion of the follower 132 to bring about stable idling. As FIGS. 1 and 3 clearly show, the follower 132 of this embodiment is arranged in a region on the outside of the cam member 124 so such adjustments can be easily made.

The contact portion 136 comes into contact with the lowest part of the cam face 126 when the engine idles, and the metering pin 121 minimizes the effective opening of the aperture 117 of the fuel hole 114 and the air metering hole 116. As the throttle valve 103 begins to open, the contact portion 132 makes contact with gradually higher parts of the cam face 126, increasing the effective opening of the aperture 117 and the metering hole 116. When the throttle 103 is fully open, the opening of the aperture 117 of the fuel hole 114 and the air metering hole 116 is at maximum.

In this embodiment, the flow rate characteristic of the fuel can be set arbitrarily by the shape of the cam 125, the size and shape of the air metering hole 116 or slide portion 122 of the metering pin 121, and, in particular, the shape of the tip 120 of the metering pin 121. The stroke of the metering pin 121 may be set as desired with the cam 125 irrespective of the opening and closing of the throttle valve 103, and the position of the metering pin 121 relative to the air-fuel nozzle 111 can be adjusted with the adjustment screw portion of the follower 132, thereby eliminating design and manufacturing problems and paving the way for miniaturization of the carburetor as a whole.

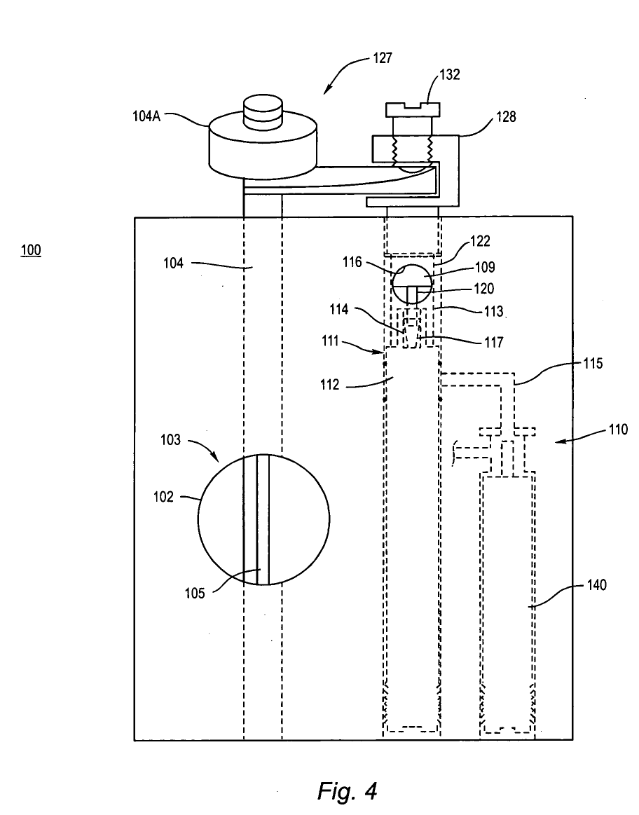

In an alternative embodiment shown in FIG. 4, the carburetor 100 includes an adjustable fuel nozzle 112 comprising an elongate body threadibly received in the carburetor body 101. As depicted, adjustment of the fuel nozzle 112 and the metering needle 140 of the high speed fuel nozzle 110 can be easily made from the same side of the carburetor 100.

In the embodiment depicted in FIG. 5A, the nozzle 112 is fixedly mounted within the body 101 of the carburetor 100. Rotation of the adjustment screw portion of the follower 132 to adjust fuel flow at idle condition results in simultaneous adjustment of fuel and air flow by adjusting the depth of insertion of the tip 120 of the metering pin 121 into the fuel hole 114 and the slide portion 122 into the pipe 113 and, thus, adjusting of the effective opening of the aperture 117 and air metering hole 116 which . In the embodiment depicted in FIG. 5B, the nozzle 112 is adjustable or moveably mounted within the body 101 of the carburetor 100. As a result, fuel flow can be adjusted independent of the air flow by rotating the adjustment screw portion of the nozzle 112.

An alternate embodiment is provided in FIG. 6. As depicted, a metering pin 221 comprising a tip 220 disposed in a nozzle 212 having a fuel aperture 214 and a slide portion 222 slidably received in the body 201 of the carburetor, further includes a small diameter portion 235 positioned toward the top or left end of the metering pin 221. A spring 237 is preferably disposed between the small diameter portion 235 and the body 201 of the carburetor to force a contact or follower 236 in constant contact with the cam 224. In operation, the thicker portion of the cam 224 causes the metering pin 221 to move inwardly (to the right) into the body 201 of the carburetor such that the effective opening of the air metering hole (not shown; see FIGS. 3 and 4) and the fuel aperture 214 are reduced to a minimum opening at idle by the slide portion 222 and tip 220 of the metering needle 221. As the throttle is rotated toward wide-open throttle, and the cam 224 is rotated toward its thinner section, the spring 237 forces the metering pin 221 out of the carburetor body thus increasing the effective opening of the air metering hole and the fuel aperture 214.

In accordance with the present invention, as was described above, the amount of fuel supplied from a fuel nozzle disposed in the air-fuel pathway is controlled over the entire operation range of an engine by converting the opening and closing motion of a butterfly throttle valve into linear reciprocal movement of a metering pin. Therefore, with the present invention it is possible to increase the output, to optimize the fuel flow rate, to decrease the size of the entire carburetor, to facilitate design and manufacture, and to obtain a carburetor with excellent performance.

While various preferred embodiments of the invention have been shown for purposes of illustration, it will be understood that those skilled in the art may make modifications thereof without departing from the true scope of the invention as set forth in the appended claims including equivalents thereof.

1. A diaphragm-type carburetor comprising
an air intake pathway that penetrates a body,
a constant fuel chamber that is provided along one face of the body and contains a constant amount of fuel by means of a diaphragm,
a butterfly-type throttle valve that opens and closes the air intake pathway,
an air-fuel pathway that penetrates the body between the air intake pathway and fuel metering chamber,
a fuel nozzle that supplies fuel introduced from the constant fuel chamber to the air-fuel pathway,
a metering pin having a tip thereof inserted into the fuel nozzle,
a cam member with an arc-shaped cam face centered on a valve stem of the throttle valve, and
an actuating member that makes constant contact with the cam face and reciprocates linearly, wherein the metering pin is held by the actuating member and reciprocates linearly following the opening and closing operation of the throttle valve to control the amount of fuel supplied from the fuel nozzle to the air-fuel pathway.

2. The diaphragm-type carburetor according to claim 1, wherein the actuating member has a retaining member, a c-shaped following member, and a follower in contact with the cam face, the follower is biased against the cam face under the force of a spring interposing the retaining member and the following member, the retaining member has an open-ended, tube-like shape and is disposed in a region on the outside of the cam member, and the follower comprises adjustment screw screwed into a top leg of the following member to adjust the insertion depth of the metering pin into the fuel nozzle.

3. The diaphragm-type carburetor according to claim 1, wherein the cam member serves as a throttle lever attached to the valve stem so that acceleration control is transmitted to and opens or closes the throttle valve.

4. A diaphragm-type carburetor comprising
an air intake pathway that penetrates a body,
a constant fuel chamber that is provided along one face of the body and contains a constant amount of fuel by means of a diaphragm,
a butterfly-type throttle valve that opens and closes the air intake pathway,
an air-fuel pathway that penetrates the body between the air intake pathway and fuel metering chamber,
a fuel nozzle that is moveably mounted within the body and supplies fuel introduced from the constant fuel chamber to the air-fuel pathway,
a metering pin having a tip thereof inserted into the fuel nozzle,
a cam member with an arc-shaped cam face centered on a valve stem of the throttle valve, and
an actuating member that makes constant contact with the cam face and reciprocates linearly, wherein the metering pin is held by the actuating member and reciprocates linearly following the opening and closing operation of the throttle valve to control the amount of fuel supplied from the fuel nozzle to the air-fuel pathway.

5. The diaphragm-type carburetor according to claim 4, wherein the actuating member has a retaining member, a c-shaped following member, and a follower in contact with the cam face, the follower is biased against the cam face under the force of a spring interposing the retaining member and the following member, the retaining member has an open-ended, tube-like shape and is disposed in a region on the outside of the cam member, and the follower comprises adjustment screw screwed into a top leg of the following member to adjust the insertion depth of the metering pin into the fuel nozzle.

6. The diaphragm-type carburetor according to claim 1, wherein the cam member serves as a throttle lever attached to the valve stem so that acceleration control is transmitted to and opens or closes the throttle valve.
